(19) United States
(12) Patent Application Publication
(10) Pub. No.: US 2011/0001882 A1
(43) Pub. Date: Jan. 6, 2011

(54) METHOD AND SYSTEM FOR DETERMINING MOTION VECTORS FOR FLAT REGIONS

(75) Inventor: Piergiorgio SARTOR, Fellbach (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/824,755

(22) Filed: Jun. 28, 2010

(30) Foreign Application Priority Data
Jul. 6, 2009 (EP) 09164627.3

(51) Int. Cl. H04N 5/14

(52) U.S. Cl. 348/699; 348/E05.066

(57) ABSTRACT

The present invention proposes a method and system for providing reliable motion estimation even for flat regions. For this purpose the block under processing is checked for flatness. In case of flatness at least one motion vector among the motion vectors associated to blocks being neighboring blocks to the block under processing is selected as candidate vector. The block under processing and at least one further block in a following frame, to which the at least one candidate vector is pointing, are compared and one candidate vector is adopted as motion vector for the block under processing in case that at least one further block is similar to the block under processing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to a method and system for determining motion vectors for flat regions. More specifically, the present invention relates to a robust motion estimation for unreliable areas or regions within an image.

Motion estimation (ME) usually relies on video streams having enough information in order to be able to measure the motion of objects. It can happen, however, that the video stream has parts, like almost flat areas, where there is not enough information that can support a proper motion measurement. Sometimes this might not be a problem, since a wrong motion vector will not disturb a later processing using it. Sometimes, due to the picture content, a wrong vector can lead to problems in the subsequent processing using it, even in almost flat areas.

(2) Description of Related Art Including Information Disclosed under 37 CFR 1.97 and 1.98

The document “Complexitiy Scalable Motion Estimation” by Ralph Braspenning et al., describes how among a plurality of motion vectors one or more median vectors can be selected.

The European patent application EP1 840 823 A1 describes a method for determining flat regions within an image.

### BRIEF SUMMARY OF THE INVENTION

It is therefore the object of the present invention to improve the prior art.

According to one aspect the present invention relates to a method for determining motion vectors for flat regions, comprising the steps of selecting at least two motion vectors among vectors associated to blocks being neighboring blocks to a block under processing in a current image frame, determining whether the block under processing is a flat region, selecting in case of a flat block under processing one of the previously selected motion vectors as candidate for the block under processing, comparing the block under processing with a further block in a following image frame to which the candidate vector is pointing, and accepting the candidate vector as motion vector for the block under processing in case that the block under processing and the further block are similar.

According to a further aspect the present invention relates to a system for determining motion vectors for flat regions, comprising a selector configured to select at least two motion vectors among vectors associated to blocks being neighboring blocks to a block under processing in a current image frame,

a determinator configured to determine whether the block under processing is a flat region,

a candidate selector configured to select in case of a flat block under processing at least one of the previously selected motion vectors as candidate for the block under processing,

a comparator configured to compare the block under processing with at least one further block in a following image frame to which the at least one candidate vector is pointing, and

a storage configured to store one candidate vector as motion vector for the block under processing in case that at least one further block is similar to the block under processing.

According to a further aspect the present invention relates to a computer program product stored on a computer readable medium which causes a computer to perform the steps of selecting at least two motion vectors among vectors associated to blocks being neighboring blocks to a block under processing in a current image frame,

determining whether the block under processing is a flat region, selecting in case of a flat block under processing one of the previously selected motion vectors as candidate for the block under processing,

comparing the block under processing with a further block in a following image frame to which the candidate vector is pointing, and

accepting the candidate vector as motion vector for the block under processing in case that the block under processing and the further block are similar.

According to still a further aspect the present invention relates to a computer readable non-transitory medium having instructions stored thereon which, when carried out on a computer, cause the computer to perform the steps of the method according to the present invention.

### BRIEF DESCRIPTION OF THE SEVERAL VIEWS OF THE DRAWINGS

The present invention will now be explained in more detail in the following description of the preferred embodiments in relation to the enclosed drawings in which

FIG. 1 shows two subsequent image frames with motion vectors,

FIG. 2 shows two subsequent image frames with a motion vector determined according to the present invention,

FIG. 3 shows a schematic block diagram of an apparatus comprising a system according to the present invention, and

FIG. 4 shows a flow chart showing the process steps according to the method of the present invention.

### DETAILED DESCRIPTION OF THE INVENTION

The present invention relates to reliable motion estimation within video streams or video signals, which comprise several consecutive image frames or time frames. For motion estimation or other motion related processes, motion vectors indicating the motion of objects between two consecutive image frames are determined.

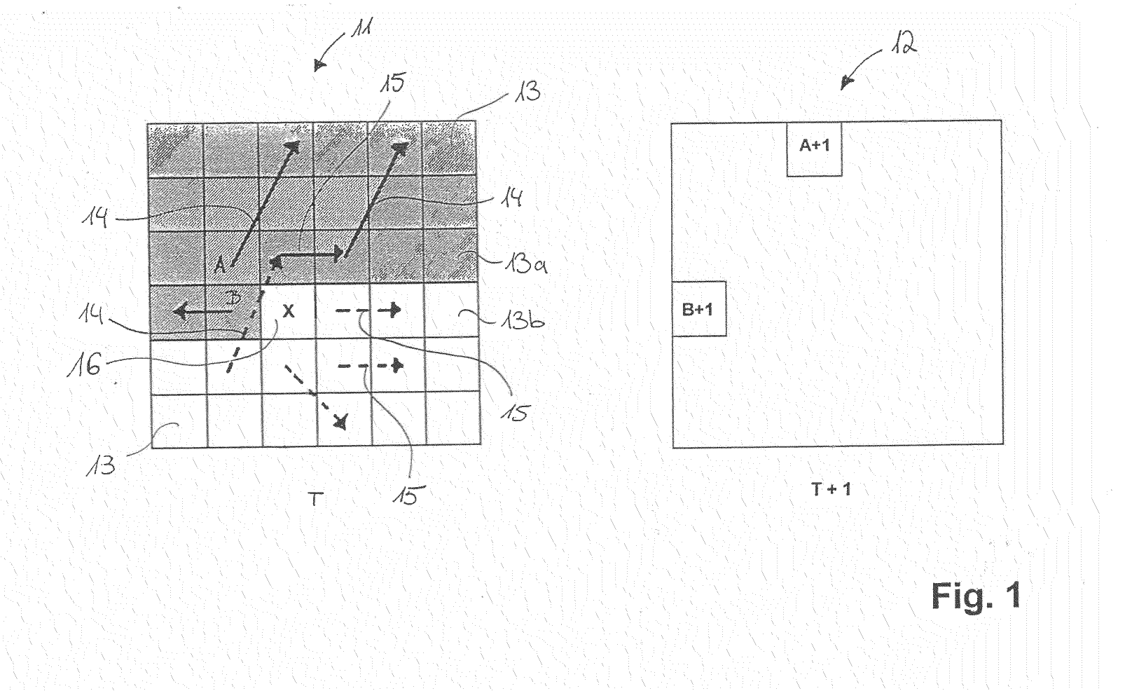

FIG. 1 shows two exemplary consecutive image frames. Hereby, a current image frame 11 at a time T is shown and a following image frame 12 at a time T+1. The current image frame 11 is also referred to as source frame, starting frame or actual frame. The following frame 12 is also referred to target frame, successive frame or next frame.

Usually, for providing motion vectors, the source frame 11 is divided into several blocks 13. The blocks hereby comprise at least one pixel, preferably comprise 8×8 pixels. For the current image frame 11, which is the image frame currently under processing, for every block 13 a corresponding motion vector is determined. The motion vector indicates the motion of an object within the current image frame 11 and the following image frame 12.

In the present example as shown in FIG. 1 the source frame is divided into blocks 13 like a chess board, with 8×8 pixels for each block. In this example each block has the upper left corner at coordinates (0,0), (0,8), (0,16), . . . (8,0), (8,8), . . . (16,0), (16,8), and so on. The target frame is not divided into blocks regularly, but the blocks are taken, e.g. for the purpose of comparison, where they are, i.e. they are not necessarily within the same grid as the grid of the source frame.

In the embodiment shown in FIG. 1 the motion vector determination starts with the first block 13 in the first line, continues with the second block in the first line and thereby goes line by line through the current image frame 11. As shown in FIG. 1 in the current image frame 11 already processed blocks 13a are shown in grey and not yet processed blocks 13b are shown in white. As an example a block under processing 16 is marked with an X.

For every block 13 within the current image frame 11 a motion vector 14, 15 is determined. In the example shown in FIG. 1 equal motion vectors are referenced with equal reference signs. As can be seen in the present example, three blocks have a common motion vector 14 and further three blocks have a common motion vector 15. For example, a motion vector 14 is assigned to a block A in the current time frame T and a corresponding block in the following time frame T+1 is indicated with A+1. Likewise, a motion vector is assigned to a block B in the current time frame T and a corresponding block in the following time frame T+1 is indicated with B+1.

Hereby the motion vectors associated to already processed blocks 13a are shown with a drawn through line. Motion vectors associated to blocks which have not yet been processed are indicated with dashed lines and refer to motion vectors determined for the respective positions in the previous image frame at time T−1.

In the above example of a source frame divided into blocks of 8×8 pixels, since a vector can have any length, this means that on the target frame a block can be considered anywhere. So if as an example for a source block (16, 16) a vector is taken with a length (5, 7), then on the target frame this will result to a block having coordinates (21,23), which is not on a grid of 8×8 pixels like in the source frame. That means that even though in the example shown in FIG. 1, the blocks A+1 and B+1 in the following time frame are on the grid of 8×8 pixels, this does not necessarily have to be the case, i.e. the blocks A+1 and B+1 can have any position in the following time frame depending on the position of the block in the current time frame and the associated motion vector.

The present invention will be explained with reference to FIG. 1 where exemplary a block under processing 16 indicated with X is currently processed. However, the present invention is applicable to any other block within the current frame 11.

For the block under processing 16 one or more neighboring blocks are defined. Blocks can be defined as neighboring blocks if being directly adjacent either in orthogonal and/or in diagonal direction or even if being not directly adjacent to the block under processing 16.

Preferably, in the present invention neighboring blocks can be defined as those four blocks which are directly adjacent in orthogonal and/or diagonal direction to the block under processing 16 and which are already processed within the current image frame 11. More specifically, in the case of a line-wise processing of the blocks within the current image frame 11, the three blocks from the line above the block under processing 16 are selected and additionally one block in the same line as the block under processing 16 depending on the scanning, i.e. processing direction. That means that in the preferred embodiment blocks are selected, which are the ones with vectors calculated in the same time instance, i.e. spatial predictors only.

In another embodiment according to the present invention neighboring blocks are defined as those eight blocks, which are adjacent to the block under processing 16 in orthogonal and diagonal direction. But any other definition of neighboring blocks can be used, i.e. any possible mask of blocks within the current image frame 11 can be defined including an arbitrary number of blocks at arbitrary positions. This includes blocks which are not directly adjacent to the block under processing 16. The mask can include any number of blocks at any position, i.e. the mask can be symmetric or asymmetric with respect to the block under processing 16. The mask can include already processed blocks 13a and/or not yet processed blocks 13b. The only condition for the neighboring blocks is that they have to be within the same frame as the block under processing 16.

In any case, motion vectors among motion vectors associated to these neighboring blocks are selected in order to determine the motion vector for the block under processing 16.

A known method is the reference motion estimation which uses the so-called parallel predictive method. This means that some motion vectors from neighboring blocks, which are already obtained by a previous spatial and/or temporal iteration, are used in the current measurement as starting point for the block under processing 16. Some random or pseudo-random variations are added to the vectors in order to account for acceleration or other motion changes. All these candidates are tested and the one with the less residual energy is taken.

However, the known method fails in case that the block under processing 16 is a flat region. A flat region in the context of the present invention is to be understood as a region having low contrast, i.e. a region where a previously described conventional motion estimation is not possible anymore.

The present invention now proposes a new solution to reduce the problems associated with flat regions.

According to the present invention at least two motion vectors among the motion vectors associated to neighboring blocks are selected. Preferably, the most common vectors among the motion vectors associated to neighboring blocks are selected and stored. The selected vectors can include spatial and/or temporal vectors with or without projection. Another method could be to choose two or more median vectors among the motion vectors associated to neighboring blocks as described in the document “Complexitiy Scalable Motion Estimation” by Ralph Braspenning et al., which is incorporated herein by reference. Two or more medians mean the median from the vector's pool, the median from the vector's pool without the previously selected one and so on.

In other words, at least two vectors among the motion vectors associated to neighboring blocks, already calculated, are selected. The selection can be independent of spatial and/or temporal vectors. In a preferred embodiment, two spatial motion vectors and one temporal motion vector are selected.

In a further alternative, as in the present embodiment as shown in FIG. 1, the two or more most common vectors are chosen, i.e. the vector selection is based on a vector majority. In the example shown in FIG. 1 the two most common vectors among the motion vectors associated to neighboring blocks are the vectors 14 and 15.

After the selection of motion vectors among the motion vectors associated to neighboring blocks it is determined whether the block under processing 16 is a flat block, i. e. is a flat region. The detection of a flat region in an image can be accomplished according to the method described in European patent application EP 1 840 823 A1, which is incorporated herein by reference. This method can be used, or a simplified version of it, if stability is not a requirement. Another option is to use other criteria like Haar transform or Fourier transform or DCT measurement or other suitable methods.

Generally, a flat or homogeneous region comprises a low contrast, that is the difference between the maximum luminance and the minimum luminance is low. One possible criterion is to calculate the maximum variance for a block and to define a block as flat in case the variance of the block is 10% or less of the maximum variance.

The flatness can be detected by measuring the variance or the absolute statistical moment of specific values, e.g. pixels, average or the like.

In case that the flatness of the block under processing 16 is detected, at least one of the previously selected motion vectors is selected as candidate vector for the block under processing 16. In a preferred embodiment all previously selected motion vectors are selected as candidate vectors for the block under processing and the best motion vector is determined. In an alternative embodiment, only one vector can be selected as candidate vector and further candidate vectors are only selected in case the first selected candidate vector turns out to be not appropriate.

In the following, the preferred embodiment of selecting all of the previously selected vectors as candidate vectors will be described, however, it is to be noted, that also other embodiments including selection of only one or fewer than all previously selected vectors are intended to be covered by the present invention.

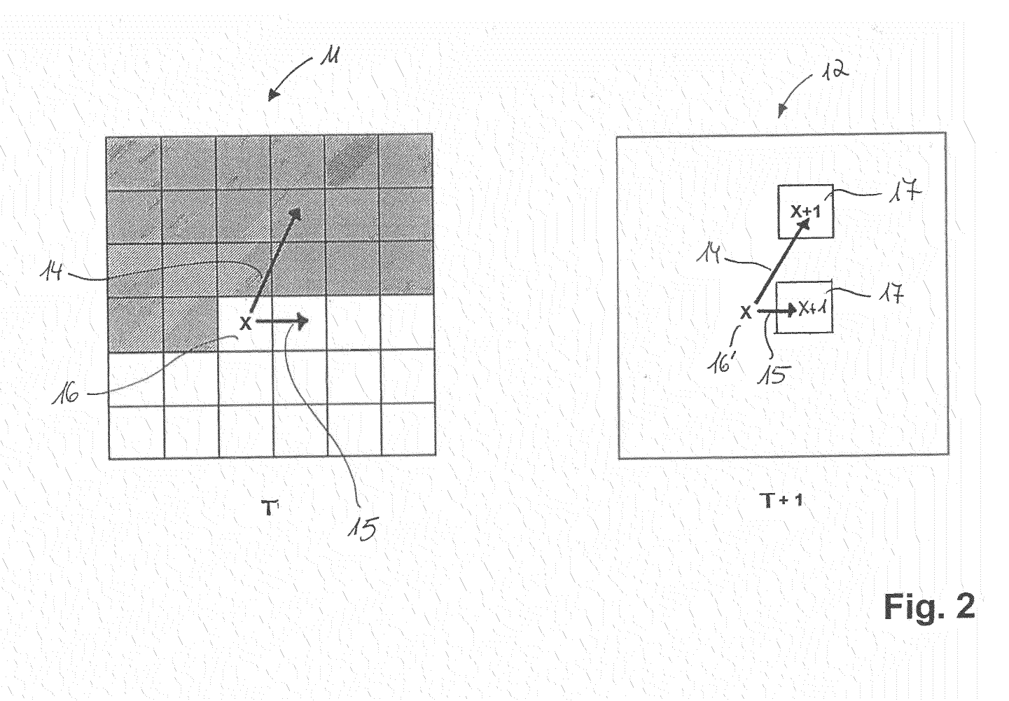

This is shown in FIG. 2. In this example the vectors 14 and 15 are selected as candidate vectors. Then it is determined to which further blocks in the following frame 12 the candidate vectors when starting from the block under processing 16 are pointing. This is shown in FIG. 2 in the following frame 12, where the further blocks 17 indicated by the candidate vectors 14 and 15 are shown. For a matter of clearness the position of the block under processing 16′ is also indicated in the following time frame 12.

The further blocks 17 to which the candidate vector is pointing and the block under processing 16 are compared, i. e. it is checked, whether the blocks are similar compared to a predefined threshold. More specifically, if the further blocks 17 are also flat, then they will be result as being more similar to the block under processing than a block which is not flat.

Each of the further blocks 17 is compared with the block under processing 16 according to the following similarity check. First, a pixel by pixel difference is calculated between the further block 17 and the block under processing 16. Preferably, the absolute difference between the pixels of the blocks is calculated. This has the advantage that the module for calculating the absolute difference “absdiff”, which in a preferred embodiment is already present for detecting the flatness, can also be used for the similarity check. By calculating the absolute difference and reusing already existing components therefore a simplified implementation becomes possible. The resulting block, which comprises at least one pixel, e.g. a size of 8×8 pixels, is checked for flatness. If the detected flatness is lower than e.g. a predefined threshold, then the compared blocks are declared similar. The more the compared blocks are similar, the more the calculated absolute difference block will be flat. The detection of flatness of the difference block is thus an indication on the similarity of the compared blocks Alternatively, the blocks are not compared, but it is only determined whether the further block 17 is also flat in accordance with the methods described earlier.

If only one of the further blocks 17 is similar to the block under processing 16, then the present candidate vector is adopted as an appropriate vector and accepted as motion vector for the block under processing 16 and stored in a storage or buffer.

If more than one of the further blocks 17 are similar to the block under processing 16, then the one further block 17 is selected, which is most similar, i.e. the further block for which the difference block is most flat. The corresponding vector is then adopted as an appropriate vector and accepted as motion vector for the block under processing 16 and stored in a storage or buffer.

In case none of the further blocks 17 are similar to the block under processing 16, i.e. not flat, then either the conventional motion estimation could be adopted or alternatively a further candidate vector can be selected from any further block in order to determine an optimum motion vector for the block under processing 16. The process of subsequently selecting new candidate vectors can be continued until all or a defined number of vectors among the motion vectors associated to blocks within the same frame as the block under processing have been tested. In case an appropriate motion vector is found, this vector is adopted as motion vector for the block under processing. Otherwise, the conventional motion estimation is used.

For the conventional motion estimation, the selected motion vectors among the motion vectors associated to neighboring blocks can be used as spatial predictors and additionally some other motion vectors can be used.

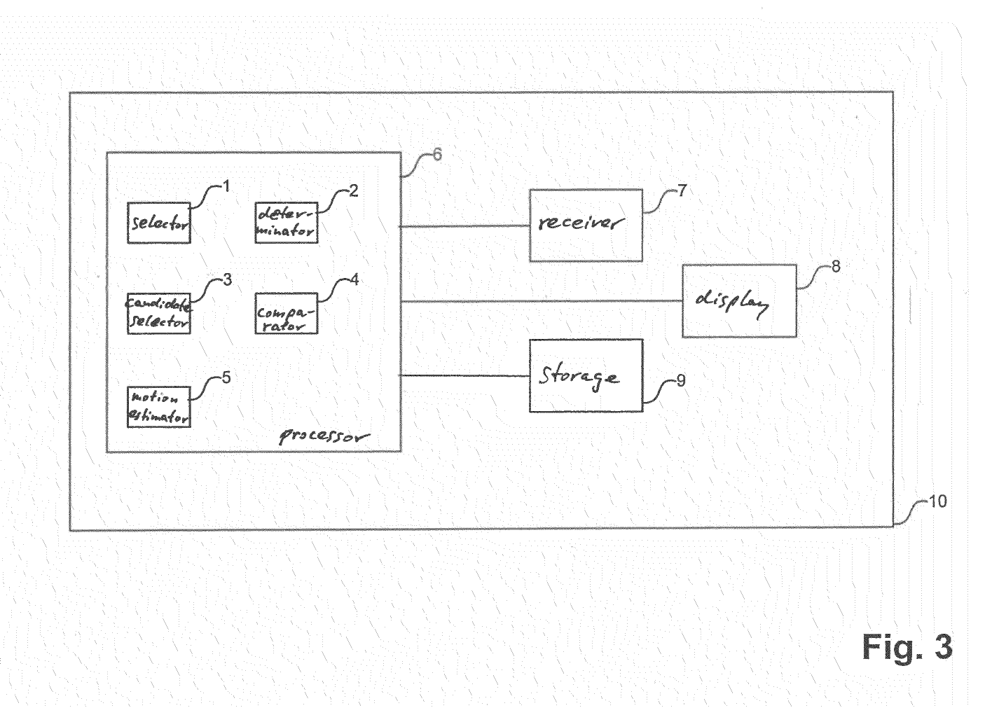

FIG. 3 shows an electronic device 10 adopting a system for determining motion vectors for flat regions according to the present invention. The electronic device 10 can for example be a television, a camera or any other electronic device having the need to provide an enhanced image quality by use of motion vector based algorithms.

The electronic device 10 can comprise a receiver 7 which receives the image frames of the video signal. Alternatively, the receiver can also be an external device. The electronic device 10 further comprises a storage 9 and a display 8 for displaying the processed video images. However also the display is optional and can be an external device. The storage 9 can comprise one or more storage parts of volatile and/or non-volatile memory. The display 8 can be any type of known or future display, e. g. a liquid crystal display (LCD) or the like.

The receiver 7, the display 8 and the storage 9 are connected to and in data communication with a processor 6, which supervises all processes within the electronic device 10.

The processor 6 according to the present invention comprises several components 1 to 5 adapted to carry out the steps according to the present invention. The components 1 to 5 can hereby either be processing steps within the inventive algorithms and/or hardware components for carrying out the respective algorithm steps.

Specifically the processing unit comprises a selector 1 for selecting two or more motion vectors among the motion vectors associated to blocks being neighboring blocks to the block under processing 16. Further, a determinator 2 is provided which is adapted to determine the flatness of the block under processing 16. A candidate selector 3 is adapted to select one or more vectors as candidate for the block under processing 16 from the group of vectors previously selected by the selector 1.

A comparator 4 is provided to compare the block under processing 16 with the one or more further blocks 17 within the following time frame 12 to which the previously selected candidate vectors are pointing.

Within the processor 6 further a conventional motion estimator 5 is provided which is adapted to provide a conventional motion estimation in case that the block under processing 16 is not flat or that no appropriate motion vector can be found.

The electronic device 10 is not limited to the components shown in FIG. 3, but comprises all further components necessary for the functionality of the electronic device 10, e. g. a battery, power source or the like, which are omitted in the figure for the sake of clarity.

Additionally, according to the present invention, some pre-processing steps before the flatness detection can be accomplished, like Histogram Equalization (HE), noise reduction, edge enhancement. These algorithms can be used on the block under processing 16 and/or on the further block 17, in order to improve the flatness detection itself especially in dark or very bright areas.

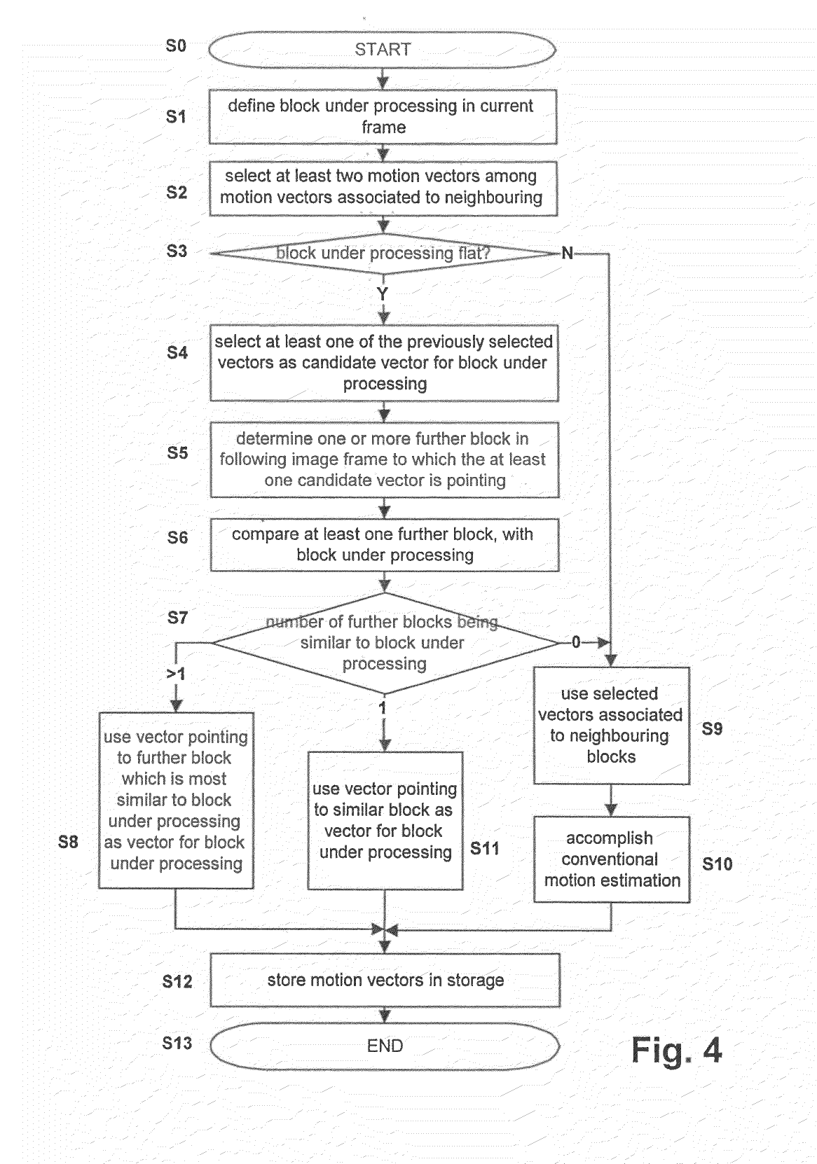

With reference to FIG. 4 now the method according to the present invention will be explained in overview.

The process starts in step S0 for example with reception of a current image frame 11 or with the finished processing of a previous block 13 within the current image frame 11.

In step S1 the block under processing 16 in the current frame 11 is defined.

In the following step S2 at least two vectors among the motion vectors associated to neighboring blocks are selected.

In step S3 the block under processing 16 is checked for flatness in accordance with the method previously described in order to detect whether the contrast difference is low.

If the block under processing has a flat region, then in the following step S4 at least one of the previously selected vectors is selected as candidate for the block under processing 16.

In the following step then the one or more further blocks 17 in the following frame 12 is determined to which the at least one candidate vector is pointing.

In step S6 it is checked whether the block under processing 16 and the one or more further blocks 17 are similar, i. e. whether the further blocks 17 are also flat. For this purpose the absolute difference between the pixels of the block under processing 16 and the further block 17 is calculated and compared with a predefined threshold, as has previously been described in detail.

Advantageously, for the comparison of the block under processing 16 and the further blocks 17 the “absdiff” module, which is already present, can be used so that no or only a few additional components are required.

In the next step S7 it is determined how many further blocks 17 are similar to the block under processing 16 and then the method continues with different steps.

If no further block 17 is similar to the block under processing 16, then in the next step S9 the at least two vectors associated to neighboring blocks are used to accomplish a convention motion estimation in step S10. As previously described, in an alternative embodiment (not shown in FIG. 4) instead of going directly to the conventional motion estimation, any other vector can be selected as candidate vector for the block under processing and again the similarity of the further block 17 to which this new candidate vector is pointing and the block under processing can be determined.

If in step S7 it is decided that only one further block 17 is similar to the block under processing 16, then in step S11 the one vector pointing to this one further block 17 is used as vector for the block under processing 16.

Otherwise, if in step S7 it is decided that more than one further blocks 17 are similar to the block under processing, then in step S8 it is checked, which of the further blocks 17 is the one most similar to the block under processing, i.e. for which one of the further blocks 17 the absolute difference is most flat. The vector pointing to the most similar further block 17 is then used as motion vector for the block under processing 16.

Otherwise, if in step S3 it is decided that the block under processing 16 is not flat then the process continues with step S9, where the previously selected at least two vectors are used for accomplishing a conventional motion estimation in step S10.

In any case, the obtained motion vectors are output to a storage in step S12.

The process ends in step S13.

To summarise, the state of the art does not use flatness in order o improve the motion estimation process, but only to reduce the computation load. On the other hand, flatness detection as such is not very reliable. With the present invention, the stability and robustness in increased by second check, which is not a simple block matching but a similarity measurement. The second check uses the same methods, i.e. block difference and flatness, so the same logic and routing already available can be used without the need of further computational blocks.

Further, the choice of at least two motion vectors among the motion vectors associated to neighboring blocks assures that always two different vectors (if available) will be later checked in case of no flat regions.

The present system, method and computer program product can specifically be used when displaying images in non-stroboscopic display devices, in particular Liquid Crystal Display Panels (LCDs), Thin Film Transistor Displays (TFTs), Color Sequential Displays, Plasma Display Panels (PDPs), Digital Micro Mirror Devices or Organic Light Emitting Diode (OLED) displays.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for determining motion vectors for flat regions, comprising the steps of
selecting at least two motion vectors among vectors associated to blocks being neighboring blocks to a block under processing in a current image frame,
determining whether the block under processing is a flat region,
selecting in case of a flat block under processing at least one of the previously selected motion vectors as candidate for the block under processing,
comparing the block under processing with at least one further block in a following image frame to which the at least one candidate vector is pointing, and
accepting in case that at least one further block is similar to the block under processing one candidate vector as motion vector for the block under processing.

2. The method according to claim 1,
further comprising the step of defining as neighboring blocks four blocks being directly adjacent to the block under processing and being already processed within the current frame.

3. The method according to claim 1,
wherein as motion vectors associated to neighboring blocks motion vectors from a previous spatial and/or temporal iteration are selected.

4. The method according to claim 1,
wherein as candidate vectors motion vectors are selected being the median vectors of the vectors associated to neighboring blocks.

5. The method according to claim 1,
wherein as candidate vectors motion vectors are selected being the most common vectors among the vectors associated to neighboring blocks.

6. The method according to claim 1,
wherein the detection of flatness is accomplished by calculating measuring the variance or absolute statistical moment and comparing this result to a predefined threshold.

7. The method according to claim 1,
wherein the comparison of the block under processing and the further block is accomplished by calculating the absolute difference between the pixels in the block under processing and the further block and
further comprising the step of comparing the absolute difference to a predefined threshold.

8. The method according to claim 1,
wherein in case that only one further block is similar to the block under processing, the corresponding one candidate vector is accepted as motion vector for the block under processing.

9. The method according to claim 1,
wherein in case that more than one further blocks are similar to the block under processing, the one candidate vector is accepted a s motion vector for the block under processing, which is pointing to the further block which is most similar to the block under processing.

10. The method according to claim 1,
further comprising the step of pre-processing of the block under processing before the step of detecting flatness, preferably by histogram equalization, noise reduction and/or edge enhancement.

11. System for determining motion vectors for flat regions, comprising
a selector configured to select at least two motion vectors among vectors associated to blocks being neighboring blocks to a block under processing in a current image frame,
a determinator configured to determine whether the block under processing is a flat region,
a candidate selector configured to select in case of a flat block under processing at least one of the previously selected motion vectors as candidate for the block under processing,
a comparator configured to compare the block under processing with at least one further block in a following image frame to which the at least one candidate vector is pointing, and
a storage configured to store one candidate vector as motion vector for the block under processing in case that at least one further block is similar to the block under processing.

12. System for determining motion vectors for flat regions, comprising
a selecting means for selecting at least two motion vectors among vectors associated to blocks being neighboring blocks to a block under processing in a current image frame,
a determining means for determining whether the block under processing is a flat region,
a candidate selecting means for selecting in case of a flat block under processing at least one of the previously selected motion vectors as candidate for the block under processing,
a comparing means for comparing the block under processing with at least one further block in a following image frame to which the at least one candidate vector is pointing, and
a storing means for storing one candidate vector as motion vector for the block under processing in case that at least one further block is similar to the block under processing.

13. A computer program product stored on a computer readable medium which causes a computer to perform the steps of
selecting at least two motion vectors among vectors associated to blocks being neighboring blocks to a block under processing in a current image frame,
determining whether the block under processing is a flat region,
selecting in case of a flat block under processing at least one of the previously selected motion vectors as candidate for the block under processing,
comparing the block under processing with at least one further block in a following image frame to which the at least one candidate vector is pointing, and
accepting one candidate vector as motion vector for the block under processing in case that at least one further block is similar to the block under processing.

14. Computer readable non-transitory medium having instructions stored thereon which, when carried out on a computer, cause the computer to perform the steps of the method as claimed in claim 1.
